(19) United States
(12) Patent Application Publication
(10) Pub. No.: US 2024/0271258 A1
(43) Pub. Date: Aug. 15, 2024

(54) Fe-Co ALLOY FOR SOFT MAGNETIC MEMBER, AND SOFT MAGNETIC MEMBER USING SAME

(71) Applicant: DAIDO STEEL CO., LTD., Nagoya-shi (JP)

(72) Inventor: Takamasa SATO, Nagoya-shi (JP)

(21) Appl. No.: 18/431,124

(22) Filed: Feb. 2, 2024

(30) Foreign Application Priority Data
Feb. 10, 2023 (JP) 2023-018879
Dec. 12, 2023 (JP) 2023-209239

(51) Int. Cl. C22C 38/10; C22C 38/00; C22C 38/02; C22C 38/06; H01F 1/147

(52) U.S. Cl. CPC C22C 38/10; C22C 38/002; C22C 38/02; C22C 38/06; H01F 1/147

(57) ABSTRACT

The present invention relates to a Fe—Co alloy for a soft magnetic member, including an alloy composition that includes, in terms of mass %, 10.00%<Co≤20.00%, 0.10%≤Si<2.0%, 0.10%≤Al<2.0%, and 0.01%<M<0.10%, provided that M is Ta or Y; with the balance being Fe and unavoidable impurities, and relates to a soft magnetic member.

### CROSS-REFERENCE TO RELATED APPLICATIONS

This application is based on and claims priority under 35 USC 119 from Japanese Patent Applications No. 2023-018879 filed on Feb. 10, 2023 and No. 2023-209239 filed on Dec. 12, 2023, the contents of which are incorporated herein by reference.

### TECHNICAL FIELD

The present invention relates to a Fe—Co alloy for a soft magnetic member including Si and Al, and a soft magnetic member using the same.

### BACKGROUND ART

Electromagnetic steel sheet made of an alloy including Fe and Si have magnetic properties such as a high magnetic permeability (μ), a low loss (Pcm), and a high saturation magnetic flux density (Bs), and are thus widely used as motor core materials. On the other hand, in response to recent demands for higher output and smaller size of motors, a soft magnetic alloy in which Co is added to Fe, which can have a higher saturation magnetic flux density, has been developed. For example, a Fe-49Co-2V material, commonly known as “Permendur”, which has an excellent balance between the saturation magnetic flux density (Bs) and the magnetic permeability (u) is known. On the other hand, since Co is a very expensive element compared to Si and the like, a soft magnetic alloy in which an amount of Co is reduced has also been proposed.

For example, Patent Literature 1 discloses a Fe—Co based soft magnetic alloy including Si and Al for forming a magnetic part such as a core of a transformer. When a content of Co is less than 35%, Si and Al are added according to the content of Co. Such an alloy is subjected to multiple times of cold rolling and annealing treatment (heat treatment) to obtain a sheet or a strip. An upper limit of the amount of Co added is determined so as to prevent rapid and sudden occurrence of regular-irregular transformation during the annealing treatment.
Patent Literature 1: JP2018-529021A

### SUMMARY OF THE INVENTION

As described above, Co is a very expensive element, and the above electromagnetic steel sheet including a large amount of Co has a problem in terms of cost. Further, when a large amount of Co is included, a brittle phase (ordered phase) is generated, which leads to problems in producibility, such as inability to form a specified product unless working and annealing conditions are appropriately controlled to ensure cold workability.

The present invention has been made in view of the above circumstances, and an object thereof is to provide a Fe—Co alloy for a soft magnetic member including Si and Al, having excellent producibility without impairing cold workability, and satisfying magnetic properties required for a soft magnetic member, particularly having a reduced loss, by adjusting an amount of Co added to Fe and adding other elements, and a soft magnetic member using the same.

A Fe—Co alloy for a soft magnetic member according to the present invention has an alloy composition that includes, in terms of mass %, 10.00%<Co≤20.00%, 0.10%≤Si<2.0%, 0.10%≤Al<2.0%, and 0.01%<M<0.10%, provided that M is Ta or Y, with the balance being Fe and unavoidable impurities.

According to such a feature, it is possible to satisfy the magnetic properties required for a soft magnetic member, and to have excellent cold workability and ensure high producibility.

In the above invention, the alloy composition may include at least one of V and Cr, and satisfy V≤2.0%, Cr≤2.0%, and V+Cr≤2.0%. Additionally, the alloy composition may satisfy 0.10%<V<2.0%, 0.10%<Cr<2.0%, and 0.10%<V+Cr<2.0%. According to such a feature, it is possible to reliably satisfy the magnetic properties required for a soft magnetic member, and to have excellent cold workability and ensure high producibility.

In the above invention, the unavoidable impurities may include C: 0.020% or less, Mn: less than 0.10%, P: 0.010% or less, S: 0.005% or less, Cu: 0.05% or less, Ni: 0.10% or less, Mo: 0.10% or less, Ti: 0.010% or less, O: 0.005% or less, and N: 0.005% or less. According to such a feature, it is possible to ensure production stability, to satisfy the magnetic properties required for a soft magnetic member, and to have excellent cold workability and ensure high producibility.

In addition, a soft magnetic member according to the present invention includes: a Fe—Co alloy which has an alloy composition including, in terms of mass %, 10.00%<Co≤20.00%, 0.10%≤Si<2.0%, 0.10%≤Al<2.0%, and 0.01%<M<0.10%, provided that M is Ta or Y, with the balance being Fe and unavoidable impurities, and which has an average crystal grain size of 50 μm or more, in which a magnetic adjustment treatment is performed to have a core loss of 200 W/kg or less at 1.5 T and 1 kHz.

According to such a feature, it is possible to satisfy the magnetic properties required for a soft magnetic member, and to have excellent cold workability and high producibility.

In the above invention, the alloy composition may include at least one of V and Cr, and satisfy V≤2.0%, Cr≤2.0%, and V+Cr≤2.0%. Additionally, the alloy composition may satisfy 0.10%<V<2.0%, 0.10%<Cr<2.0%, and 0.10%<V+Cr<2.0%. According to such a feature, it is possible to reliably satisfy the magnetic properties required for a soft magnetic member, and to have excellent cold workability and high producibility.

In the above invention, the unavoidable impurities may include C: 0.020% or less, Mn: less than 0.10%, P: 0.010% or less, S: 0.005% or less, Cu: 0.05% or less, Ni: 0.10% or less, Mo: 0.10% or less, Ti: 0.010% or less, O: 0.005% or less, and N: 0.005% or less. According to such a feature, it is possible to ensure production stability, to reliably satisfy the magnetic properties required for a soft magnetic member, and to have excellent cold workability and high producibility.

### BRIEF DESCRIPTION OF DRAWINGS

FIG. 1 is a flow diagram showing an example of a method for producing a soft magnetic member according to the present invention.

FIG. 2 is a list of component compositions of alloys used in production tests.

FIG. 3 is a list of properties of alloy materials and soft magnetic members obtained in the production tests.

### DESCRIPTION OF EMBODIMENTS

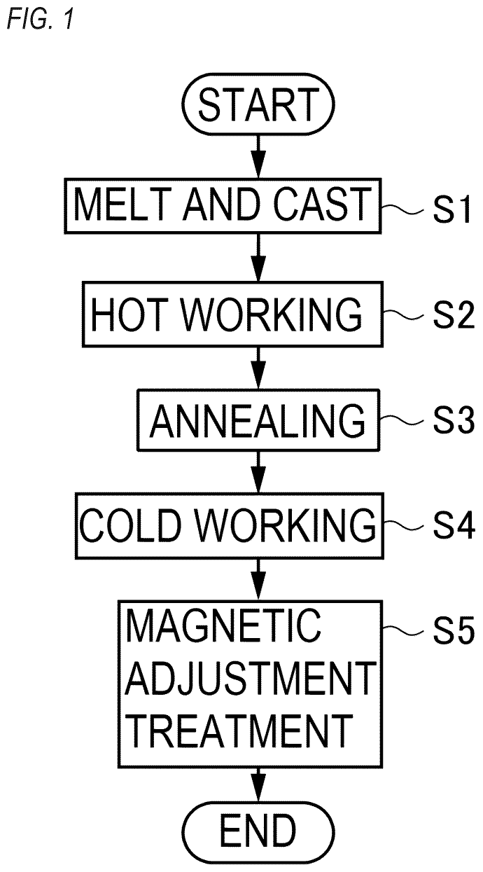

A soft magnetic member, a Fe—Co alloy for a soft magnetic member as an intermediate thereof, and a preform material for a soft magnetic member according to one embodiment of the present invention will be described with reference to FIG. 1.

As shown in FIG. 1, the soft magnetic member is produced, for example, by the following production method.

First, an alloy for a soft magnetic member having a predetermined component composition is melted and cast (S1).

Here, the alloy for a soft magnetic member is a Fe—Co alloy having an alloy composition that includes, in terms of mass %, 10.00%<Co≤20.00%, 0.10%≤Si<2.0%, 0.10%≤Al<2.0%, and 0.01%<M<0.10%, provided that M is Ta or Y, with the balance being Fe and unavoidable impurities.

In this way, when the alloy composition is obtained by adjusting an amount of Co added to Fe and adding other elements, in the soft magnetic member finally obtained without impairing cold workability, the required soft magnetic properties can be obtained at a high level. In addition, when Ta or Y is added, Co₃Ta or Co₃Y, which is a diffusible compound with Co, is dispersedly formed, and a concentration of the surrounding Co is decreased. Accordingly, free energy is decreased, an amount of dislocation that can be introduced is increased, and embrittlement due to deformation is prevented. As a result, high toughness can be imparted during cold working, and high producibility can be ensured due to excellent cold workability. Note that the term “diffusible compound” refers to a compound formed by diffusion from a solid solution state.

Note that in such a Fe—Co alloy, the component is preferably adjusted such that a precipitation initiation temperature of a y phase is 950° C. or higher. When this temperature is increased, even when a magnetic adjustment treatment (magnetic annealing, heat treatment: S5) to be described later is performed, the remaining of the y phase, which is an antiferromagnetic phase, is prevented, making it easy to obtain excellent magnetic properties of the soft magnetic member.

In addition, the alloy composition may further include at least one of V and Cr, and satisfy V≤2.0%, Cr≤2.0%, and V+Cr≤2.0%. Additionally, the alloy composition may satisfy 0.10%<V<2.0%, 0.10%<Cr<2.0%, and 0.10%<V+Cr<2.0%. Accordingly, electrical resistance of the soft magnetic member cam be improved, and an eddy current loss can be reduced.

The alloy composition may include, in terms of mass %, C: 0.020% or less, Mn: less than 0.10%, P: 0.010% or less, S: 0.005% or less, Cu: 0.05% or less, Ni: 0.10% or less, Mo: 0.10% or less, Ti: 0.010% or less, O: 0.005% or less, and N: 0.005% or less. These are impurities whose amounts are desired to be reduced as much as possible, and are allowed to be included within a range that does not influence the properties such as magnetic properties of the soft magnetic member. With a production process in which these impurities are specified, the quality is stabilized and the production stability is improved.

The cast alloy for a soft magnetic member is then subjected to hot working (S2). Here, the cast alloy is formed into the shape of an alloy material, such as a billet, to be described later, by blooming, hot forging, and/or hot rolling. In the hot working, a heating temperature in at least a final step of applying a strain is preferably lower than the precipitation initiation temperature of the y phase, for example, preferably 900° C. or lower. Accordingly, growth of crystal grains during the hot working is prevented, and an average crystal grain size can be made 200 μm or less in the alloy material for a soft magnetic member obtained after annealing (S3) to be described later. In this way, the crystal grain size is kept relatively small during the hot working, whereby cracks during cold working (S4) to be described later can also be prevented. Note that it is preferable that the heating temperature in steps other than the final step of applying a strain during the hot working is lower than the precipitation initiation temperature of the y phase from the viewpoint of keeping the crystal grain size small, but may be higher than the precipitation initiation temperature in consideration of a load on forging equipment.

Subsequently, annealing is performed to remove a working strain (S3), and the average crystal grain size is adjusted to 200 μm or less to obtain an alloy material for a soft magnetic member. Here, in order to prevent excessive grain growth, it is preferable to maintain heating at a temperature within a range of 700° ° C. to 900° C., for example. Depending on the working strain in the hot working (S2), recrystallization may occur, and accordingly, the size of crystal grains can be reduced and coarsening due to grain growth can be prevented. The alloy material obtained here can be, for example, a plate material having a thickness of 1.0 mm to 10.0 mm.

The alloy material prepared by the annealing is subjected to cold working (S4), and a working strain is applied to obtain a preform material for a soft magnetic member having a cold-worked structure due to the cold working. Here, the working strain is applied in advance to recrystallize and refine the crystal grains in the magnetic adjustment treatment (magnetic annealing, heat treatment: S5) to be described later. As the cold working, known working method such as cold rolling or cold drawing can be used. In addition, when cold working cannot be performed in one pass, it can be performed in multiple passes. In this case, intermediate annealing may be performed in order to facilitate the cold working. The intermediate annealing is performed at a temperature within a range of 600° C. to 900° C. in order to prevent excessive grain growth while removing the working strain that impedes the cold working. Accordingly, a preform material for a soft magnetic member having a cold-worked structure by the cold working can be obtained. The preform material for a soft magnetic member can be, for example, a plate-shaped body having a thickness of 0.01 mm to 0.9 mm.

The obtained preform material for a soft magnetic member is heated and subjected to a magnetic adjustment treatment (magnetic annealing: S5). The magnetic adjustment treatment is magnetic annealing for reducing a core loss by coarsening the crystal grains, and is preferably performed at a high temperature close to the precipitation initiation temperature of the y phase. For example, it is maintained at a temperature within a range of 850° C. to 950° C. under a non-oxidizing atmosphere such as vacuum or ammonia decomposition gas. Accordingly, a soft magnetic member having an excellent core loss can be obtained by coarsening the alloy structure and obtaining a structure having an average crystal grain size of 40 μm or more. Note that, it is preferable that a cooling rate in the magnetic annealing (S5) is rapid to prevent generation of a Ta carbide or a Y carbide as much as possible. The content of Ta carbide or the content of the Y carbide is preferably 0.10 mass % or less, more preferably 0.050 mass % or less.

In this way, an alloy material for a soft magnetic member is obtained by the annealing (S3) after the hot working (S2) for the alloy for a soft magnetic member, a preform material for a soft magnetic member is obtained by the cold working (S4), and a soft magnetic member having a recrystallized structure due to release of the working strain can be obtained after the magnetic adjustment treatment (S5). Particularly, by adjusting the content of Co, soft magnetic properties required for a soft magnetic member can be obtained in a high level without impairing the cold workability.

### [Production Tests]

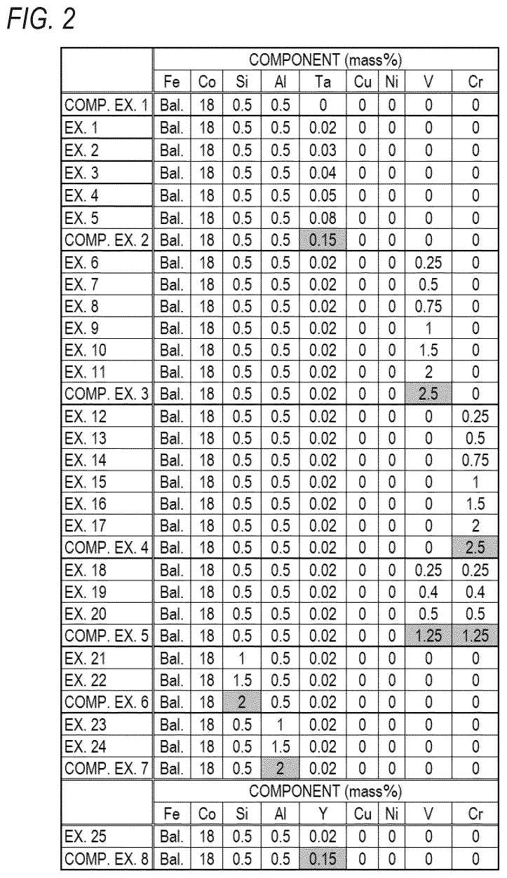

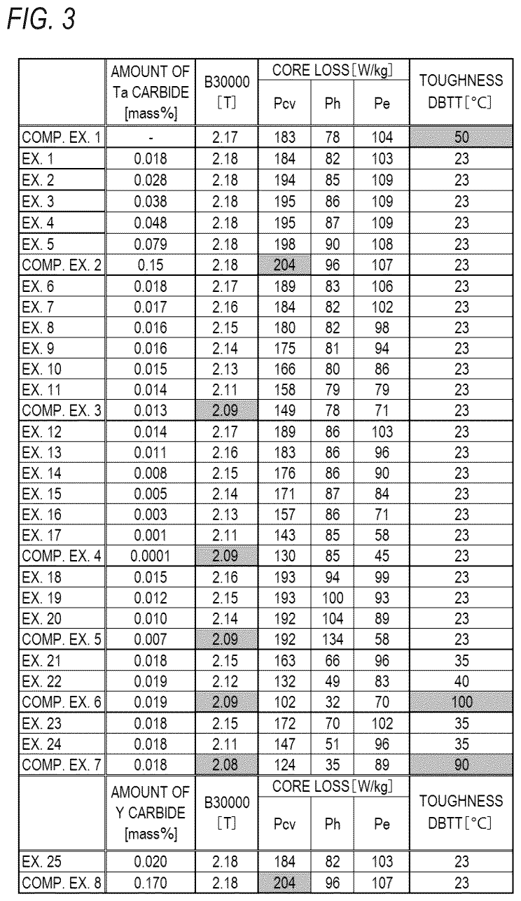

Next, test results obtained by actually producing a soft magnetic member will be described using FIG. 2 and FIG. 3.

As shown in FIG. 2, first, alloys having component compositions shown in Examples 1 to 25 and Comparative Examples 1 to 8 were melted in a vacuum induction furnace and cast into steel ingots. Each of the obtained steel ingots was bloomed, heated to 1100° C. and subjected to hot forging, and then heated to 900° C. and subjected to hot rolling, to produce a plate-shaped coil having a thickness of 2.5 mm to 4.0 mm. Further, scales were removed, and annealing was performed by holding at a temperature of 750° ° C. for 6 hours in a nitrogen atmosphere. The remaining alloy material was further subjected to cold working in the order of cold rolling, intermediate annealing, and cold rolling to obtain a plate-shaped preform material for a soft magnetic member having a thickness of 0.2 mm. Thereafter, a magnetic adjustment treatment (magnetic annealing) was performed in which the preform material was held at a temperature of 850° ° C. to 950° ° C. for several minutes (for example, 4 minutes) in an inert gas atmosphere to thereby obtain a soft magnetic member.

As shown in FIG. 3, an amount of Ta carbide or Y carbide, a magnetic flux density (B30000), a core loss (Pcv), and a ductile-brittle transition temperature (DBTT) were measured for a test piece cut out from the finally obtained test material (soft magnetic member). Regarding the core loss (Pcv), a hysteresis loss (Ph) and an eddy current loss (Pe) were also measured.

The amounts of Ta carbide and Y carbide were determined based on the weight of an extraction residue obtained by a constant potential electrolytic extraction method using a non-aqueous organic solvent electrolyte. Note that the amounts of Ta carbide and Y carbide can be obtained in the same manner even when the extraction residue is obtained by acid decomposition extraction using hydrochloric acid or the like.

Regarding the magnetic flux density (B30000), five plate-shaped test pieces each having a thickness of 0.2 mm were stacked to a thickness of 1 mm, then an annular laminated core having an outer diameter of 28 mm and an inner diameter of 20 mm was cut out and prepared, and a primary winding of 350 turns and a secondary winding of 300 turns were provided. Using a known direct-current BH tracer, the magnetic flux density at a magnetic field strength H of 30000 A/m was measured and recorded. The target value of the magnetic flux density was 2.10 T or more.

Regarding the core loss, a laminated core similar to the above was prepared, and a primary winding of 100 turns and a secondary winding of 100 turns were provided. Using a known core loss measuring device (AC BH-tracer SY 8258 manufactured by IWATSU ELECTRIC CO., LTD.), the core loss Pcv of the laminated core when the primary winding was excited by an alternating magnetic field with a sine wave at 1.5 T and 1 kHz was measured based on a signal generated in the secondary winding, and the result was recorded. The target value of the core loss under these conditions was less than 200 W/kg. In addition, the hysteresis loss Ph and the eddy current loss Pe were also measured.

The eddy current loss (Pe) was calculated by subtracting the hysteresis loss (Ph) calculated with the method described below from the measured core loss (Pcv). The core loss (Pcv) was calculated by measuring the core loss at each frequency while changing frequencies with constant magnetic flux density using the AC BH-tracer. Specifically, the measured values of core loss at each frequency were divided by the frequency to create a graph. The value of the intercept extrapolated to a frequency of 0 kHz was defined as the hysteresis loss coefficient. Furthermore, the hysteresis loss at each frequency was calculated by multiplying the hysteresis loss coefficient by the frequency.

Regarding the ductile-brittle transition temperature (DBTT), an impact test was performed at the temperature of the room temperature to 423 K on the test material subjected to the annealing (S3), temperature-dependent data of a brittle fracture ratio was obtained, and the temperature at which the brittle fracture ratio was 50% was determined as the DBTT. The target value of the DBTT was lower than 50° C. to be described later.

Referring to FIG. 2 and FIG. 3, Comparative Example 1 is a Fe-18Co-0.5Si—0.5Al alloy, which has a standard component composition in the production tests. The magnetic flux density and the core loss satisfied the target values, and the DBTT was 50° C. Regarding the DBTT, in order to aim for one having toughness higher than that in Comparative Example 1, the target value was set to less than 50° C. based on the result.

In Examples 1 to 5 and Comparative Example 2, Ta was included, and the amount thereof was changed to obtain results of each test. Examples 1 to 5 all satisfied the target values. That is, by adding Ta, the toughness could be made higher than that in Comparative Example 1. On the other hand, in Comparative Example 2, the content of Ta was 0.15 mass %, which was higher than other Examples, resulting in a large hysteresis loss and a correspondingly large core loss. This is considered to be because the hysteresis loss increases due to an increase in amount of Ta carbide that becomes a pinning site of a domain wall. Based on these, in the following Examples and Comparative Examples, the content of Ta was set to 0.02 mass %.

In Examples 6 to 11 and Comparative Example 3, V was further included, and the amount thereof was changed to obtain results of each test. In these results, as the content of V increased, the eddy current loss was reduced and the core loss was also reduced. This is considered to be the result of the improved electrical resistance due to the increased content of V. However, in Comparative Example 3, which had the largest content of V, the magnetic flux density was smaller than the target value.

In Examples 12 to 17 and Comparative Example 4, Cr was included instead of V, and the amount thereof was changed to obtain results of each test. In these results, as the content of Cr increased, the eddy current loss was reduced and the core loss was also reduced. This is considered to be the result of the improved electrical resistance due to the increased content of Cr. However, in Comparative Example 4, which had the largest content of Cr, the magnetic flux density was smaller than the target value.

In Examples 18 to 20 and Comparative Example 5, V and Cr were both included, and the amounts thereof were changed to obtain results of each test. In these results, when the total content of V and Cr increased, the eddy current loss was reduced, and on the other hand, the hysteresis loss was increased, and as a result, the overall core loss did not change significantly. However, when the total content of V and Cr increased, the magnetic flux density decreased, and was smaller than the target value in Comparative Example 5.

In Examples 21 and 22 and Comparative Example 6, the content of Si was increased compared to Example 1. As the content of Si increased, both the eddy current loss and the hysteresis loss tended to decrease, and the core loss also tended to decrease. However, the magnetic flux density also tended to decrease, and was smaller than the target value in Comparative Example 6. In addition, in Comparative Example 6, the DBTT was larger than the target value. That is, the toughness was decreased.

In Examples 23 and 24 and Comparative Example 7, the content of Al was increased compared to Example 1. As the content of Al increased, both the eddy current loss and the hysteresis loss tended to decrease, and the core loss also tended to decrease. However, the magnetic flux density also tended to decrease, and was smaller than the target value in Comparative Example 7. In addition, in Comparative Example 7, the DBTT was larger than the target value. That is, the toughness was decreased.

In Example 25 and Comparative Example 8, Y was included, and the amount thereof was changed to obtain results of each test. Example 25 satisfied the target values. That is, by adding Y, the toughness could be made higher than that in Comparative Example 1. On the other hand, in Comparative Example 8, the content of Y was 0.15 mass %, which was higher than Example 25, resulting in a large hysteresis loss and a correspondingly large core loss. This is considered to be because the hysteresis loss increases due to an increase in amount of Y carbide that becomes a pinning site of a domain wall.

In this way, according to Examples 1 to 25, due to the high toughness, magnetic properties required for a soft magnetic member can be obtained, such as excellent producibility without impairing cold workability, a reduced core loss, and a high magnetic flux density.

A composition range of a Fe—Co alloy that can provide a soft magnetic member including the above Examples is determined as follows. First, essential additive elements will be described.

Co is an essential element for ensuring the magnetic properties required for a soft magnetic member, particularly for obtaining a high saturation magnetic flux density Bs. On the other hand, when Co is included excessively, a Fe—Co-based ordered phase is generated, resulting in embrittlement. In addition, since it is a very expensive raw material, it causes an increase in cost. In this regard, the content of Co is in a range of more than 10.00% to 20.00%, preferably in a range of 15.00% to 20.00%, and more preferably in a range of 16.00% to 20.00%, in terms of mass %.

Si increases the electrical resistance, ensures a low magnetocrystalline anisotropy constant and a low magnetostriction constant, which are important in soft magnetic materials, and can remarkably reduce the core loss in a high frequency region. On the other hand, when Si is included excessively, a decrease in saturation magnetic flux density Bs or embrittlement occurs. In this regard, the content of Si is in a range of 0.10% to less than 2.0%, and preferably in a range of 0.5% to 1.5%, in terms of mass %.

Al increases the electrical resistance, ensures a low magnetocrystalline anisotropy constant, which is important in soft magnetic materials, and can reduce the core loss in a high frequency region. On the other hand, when Al is included excessively, a decrease in saturation magnetic flux density Bs or embrittlement occurs. In this regard, the content of Al is in a range of 0.10% to less than 2.0%, and preferably in a range of 0.5% to 1.5%, in terms of mass %.

Ta can dispersedly form Co₃Ta, which is a diffusible compound, whereby the amount of the strain that can be introduced can be increased by decreasing the concentration of the surrounding Co, and the toughness during cold working can be increased. Accordingly Ta can improve the producibility. On the other hand, when Ta is included excessively, Ta carbides are precipitated and become pinning sites for domain walls, leading to an increase in core loss. In this regard, the content of Ta is in a range of more than 0.01% to less than 0.10%, and preferably in a range of more than 0.01% to 0.04%, in terms of mass %. Since Y also generates Co₃Y and has an effect same as Ta, it can be included instead of Ta. The content of Y is in a range of more than 0.01% to less than 0.10%, and preferably in a range of more than 0.01% to 0.04%, in terms of mass %.

Next, optionally added elements will be described.

V and Cr increase the electrical resistance and decrease the eddy current loss. To obtain such the effect, it is preferable that at least one of V or Cr is added. It is more preferable that the V is added in an amount of 0.1% or more and/or Cr is added in amount of 0.1% or more. On the other hand, when V and Cr are added excessively, the magnetic flux density decreases. In this regard, V may be added in an amount of 2.0% or less, Cr may be added in an amount of 2.0% or less, and V+Cr (total content of V and Cr) may be added in a range of 2.0% or less, in terms of mass %.

Next, elements that are impurities but are allowed to be included in order to ensure the production stability will be described.

Since C adversely influences the magnetic properties, it is desirable to reduce the amount thereof as much as possible. However, it is difficult to completely remove C that is unavoidably mixed in during the production. Therefore, considering the range that does not influence the magnetic properties of the soft magnetic member, the allowable content thereof is 0.020% or less in terms of mass %.

Since Mn forms a sulfide when combined with S and deteriorates the magnetic properties, it is desirable to reduce the amount thereof as much as possible. However, it is difficult to completely remove Mn that is unavoidably mixed in during the production. Therefore, considering the range that does not influence the magnetic properties of the soft magnetic member, the allowable content thereof is less than 0.10% in terms of mass %.

Since P adversely influences the magnetic properties regardless of the presence state thereof, it is desirable to reduce the amount thereof as much as possible. However, it is difficult to completely remove P that is unavoidably mixed in during the production. Therefore, considering the range that does not influence the magnetic properties of the soft magnetic member, the allowable content thereof is 0.010% or less in terms of mass %.

Since S forms a sulfide when combined with Mn and deteriorates the magnetic properties, it is desirable to reduce the amount thereof as much as possible. However, it is difficult to completely remove S that is unavoidably mixed in during the production. Therefore, considering the range that does not influence the magnetic properties of the soft magnetic member, the allowable content thereof is 0.005% or less in terms of mass %.

Since Cu adversely influences the magnetic properties regardless of the presence state thereof, it is desirable to reduce the amount thereof as much as possible. However, it is difficult to completely remove Cu that is unavoidably mixed in during the production. Therefore, considering the range that does not influence the magnetic properties of the soft magnetic member, the allowable content thereof is 0.05% or less in terms of mass %.

Ni is an element that has magnetism, but degrades the magnetic properties of the soft magnetic member in the above Examples, so that it is desirable to reduce the amount thereof as much as possible. However, it is difficult to remove Ni that is unavoidably mixed in during the production. Therefore, considering the range that does not influence the magnetic properties of the soft magnetic member, the allowable content thereof is 0.10% or less in terms of mass %.

Since Mo adversely influences the magnetic properties regardless of the presence state thereof, it is desirable to reduce the amount thereof as much as possible. However, it is difficult to completely remove Mo that is unavoidably mixed in during the production. Therefore, considering the range that does not influence the magnetic properties of the soft magnetic member, the allowable content thereof is 0.10% or less in terms of mass %.

Since Ti forms a carbide and a nitride by combining with C and N and deteriorates the magnetic properties, it is desirable to reduce the amount thereof as much as possible. However, it is difficult to completely remove Ti that is unavoidably mixed in during the production. Therefore, considering the range that does not influence the magnetic properties of the soft magnetic member, the allowable content thereof is 0.010% or less in terms of mass %.

Since O forms an oxide-based inclusion with various elements that are stable even at a high temperature and deteriorates the magnetic properties, it is desirable to reduce the amount thereof as much as possible. However, it is difficult to completely remove O that is unavoidably mixed in during the production. Therefore, considering the range that does not influence the magnetic properties of the soft magnetic member, the allowable content thereof is 0.005% or less in terms of mass %.

Since N forms a nitride by combining with Al and Ti and deteriorates the magnetic properties, it is desirable to reduce the amount thereof as much as possible. However, it is difficult to completely remove N that is unavoidably mixed in during the production. Therefore, considering the range that does not influence the magnetic properties of the soft magnetic member, the allowable content thereof is 0.005% or less in terms of mass %.

Although representative embodiments of the present invention have been described above, the present invention is not necessarily limited thereto, and various alternative embodiments and modifications may occur to those skilled in the art without departing from the spirit of the present invention or the scope of the appended claims.

The present application is based on Japanese Patent Applications No. 2023-018879 filed on Feb. 10, 2023 and No. 2023-209239 filed on Dec. 12, 2023, and the contents thereof are incorporated herein by reference.

What is claimed is:

1. A Fe—Co alloy for a soft magnetic member, comprising an alloy composition that comprises, in terms of mass %, 10.00%<Co≤20.00%, 0.10%≤Si<2.0%, 0.10%≤Al<2.0%, and 0.01%<M<0.10%, provided that M is Ta or Y; with the balance being Fe and unavoidable impurities.

2. The Fe—Co alloy for a soft magnetic member according to claim 1, wherein the alloy composition further comprises at least one of V or Cr, and satisfies V≤2.0%, Cr≤2.0%, and V+Cr≤2.0%.

3. The Fe—Co alloy for a soft magnetic member according to claim 1, wherein the unavoidable impurities comprise: C: 0.020% or less; Mn: less than 0.10%; P: 0.010% or less; S: 0.005% or less; Cu: 0.05% or less; Ni: 0.10% or less; Mo: 0.10% or less; Ti: 0.010% or less; O: 0.005% or less; and N: 0.005% or less.

4. The Fe—Co alloy for a soft magnetic member according to claim 2, wherein the unavoidable impurities comprise: C: 0.020% or less; Mn: less than 0.10%; P: 0.010% or less; S: 0.005% or less; Cu: 0.05% or less; Ni: 0.10% or less; Mo: 0.10% or less; Ti: 0.010% or less; O: 0.005% or less; and N: 0.005% or less.

5. The Fe—Co alloy for a soft magnetic member according to claim 1, wherein the alloy composition further comprises at least one of 0.10%<V<2.0% or 0.10%<Cr<2.0%.

6. A soft magnetic member comprising:
a Fe—Co alloy which comprises an alloy composition comprising, in terms of mass %, 10.00%<Co≤20.00%, 0.10%≤Si<2.0%, 0.10%≤Al<2.0%, and 0.01%<M<0.10%, provided that M is Ta or Y, with the balance being Fe and unavoidable impurities, and which has an average crystal grain size of 50 μm or more, wherein
a magnetic adjustment treatment is performed to have a core loss of 200 W/kg or less at 1.5 T and 1 kHz.

7. The soft magnetic member according to claim 6, wherein the alloy composition comprises at least one of V or Cr, and satisfies V≤2.0%, Cr≤2.0%, and V+Cr≤2.0%.

8. The soft magnetic member according to claim 6, wherein the unavoidable impurities comprise C: 0.020% or less, Mn: less than 0.10%, P: 0.010% or less, S: 0.005% or less, Cu: 0.05% or less, Ni: 0.10% or less, Mo: 0.10% or less, Ti: 0.010% or less, O: 0.005% or less, and N: 0.005% or less.

9. The soft magnetic member according to claim 7, wherein the unavoidable impurities comprise C: 0.020% or less, Mn: less than 0.10%, P: 0.010% or less, S: 0.005% or less, Cu: 0.05% or less, Ni: 0.10% or less, Mo: 0.10% or less, Ti: 0.010% or less, O: 0.005% or less, and N: 0.005% or less.

10. The soft magnetic member according to claim 6, wherein the alloy composition further comprises at least one of 0.10%<V<2.0% or 0.10%<Cr<2.0%.
